(19) United States
(12) Patent Application Publication
(10) Pub. No.: US 2010/0299367 A1
(43) Pub. Date: Nov. 25, 2010

(54) Keyword Searching On Database Views

(75) Inventors: Kaushik Chakrabarti, Redmond, WA (US); Surajit Chaudhuri, Redmond, WA (US); Venkatesh Ganti, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/469,399

(22) Filed: May 20, 2009

(51) Int. Cl. G06F 17/30

(52) U.S. Cl. 707/803; 719/328; 707/769; 707/713

(57) ABSTRACT

A keyword search is executed on a view of a database based on a Boolean keyword query. The view includes multiple text columns, and the keyword search is executed on each of the multiple text columns in the view. The output results from the keyword search on each of the text columns include tuple identifiers of one or more relevant tuples and a relevancy score for ranking the results of the keyword query.

### BACKGROUND

Keyword searching is a ubiquitous method for searching documents in document collections. Keyword searching has also gained popularity for use in database systems as a querying method in which users do not need to understand the data model or schema of a database to be able to search the database content. Accordingly, enabling keyword searching on enterprise databases that contain textual information is important for quickly and easily accessing the information in the database. Most commercial database systems already support full text search (FTS) functionality over individual text columns of database relations.

A database “view” can be described as a virtual table which is generated based on selected information from the database. A view is similar to an actual table of the database; however, the actual tables in the database store data, while a view is just a dynamically selected collection of data from one or more of the actual tables in the database. For example, a view may be a subset of data contained in a single table, data selected from all or portions of a plurality of tables joined together to create a single virtual table, aggregations of data of one or more tables, such as data of one or more tables that is added or averaged to create new data, or the like. For instance, in a database containing detailed sales information for multiple customers, multiple years, multiple cities, multiple products, multiple sales amounts, and the like, a view may be created that contains sales information for a particular city for a particular year. Typical commands or operators used for creating different classes of views are the “select”, “project”, “join” and “group by” operators (SPJG). Because a view is virtual, the table representing the view is not actually created and stored in an additional storage area of the database (i.e., not materialized), but is instead created dynamically from the base relations, as needed. As a consequence of this dynamic creation, views are typically updated as the underlying base relations in the database are updated. Most commercial database software supports the creation of views, including SQL Server® available from Microsoft Corporation of Redmond, Wash., and Oracle® Database 11g available from Oracle Corporation of Redwood Shores, Calif.

Particular relations between pieces of data derived from a database are referred to as “tuples”. As used herein, a tuple refers to a sequence or list of a specific number of data values, sometimes referred to as the components of the tuple. For example, a tuple with components of the respective types NAME, ADDRESS, and CITY, could be used to record that a certain person lives at a certain address in a certain city. Thus, in this example the tuple might be represented as (name, address, city). The tuples derived from databases may consist of any number of components for representing the relationships between often-disparate pieces of data from the database. A tuple that is based on a base relation (e.g., an existing table or relationship) in a database is referred to as “base” tuple, while a tuple that is based on a database view is referred to as a “view” tuple.

Conventional full text search engines in typical database systems cannot efficiently support keyword searching on views. For example, because logical units of information are often fragmented across multiple relations in the database due to database normalization, there is often no single base tuple in a database relation that contains all the query keywords submitted in a search query. In such cases, a view can be assembled by joining multiple base relations through primary-key-foreign-key relationships. View tuples that match the query keywords may then provide relevant results to the keyword search query, but these view tuples are not always easily located.

A straightforward technique for conducting keyword searching on a view is to first materialize the view (i.e., create the view and store the view as a table in a storage location), and then index and query records in the materialized view using full text search engines. The materialization approach has a significant downside in that it requires additional storage space for each such view created; the views and full text indexes have to be first materialized at index creation time and updated whenever the base relations are updated. In common scenarios, several views have to be enabled for keyword search. Therefore, the materialization approach requires considerable space and time resources, and hence is undesirable.

Some alternative techniques have been proposed to support keyword searching on primary-key-foreign-key join views by leveraging full text indexes on the base relations. However, most of these techniques perform explicit enumeration, i.e., issue full text search queries for all keyword-to-column assignments, and require users or applications to specify the keyword-to-column assignments. Furthermore, these explicit enumeration techniques do not exploit early termination and are not efficient for Boolean expressions other than “AND” in a keyword query.

Several other techniques propose to model the database as a graph with the tuples as nodes and the primary key-foreign key relationships as edges. However, these approaches require the graph (and specialized indexes) to be materialized and maintained in the database, which wastes storage space. Similar such techniques have also been explored in the context of keyword search over XML databases.

Furthermore, one notable family of algorithms proposed for processing “top-K” queries is the TA (threshold algorithm) family of algorithms. However, it should be noted that TA cannot be directly applied in database views, such as those addressed herein, since the matching tuples from the different base relations cannot be intersected directly. Additionally, conventional TA techniques require the results of the FTS queries to be sorted, which adds significant overhead to the overall query execution time.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein use full text search indexes over base relations and hence add no additional space or maintenance overhead for efficiently returning one or more tuples determined to be most relevant to a query involving an arbitrary Boolean expression of keywords.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an exemplary architecture according to some implementations disclosed herein.

FIG. 2 illustrates an exemplary hardware and logical configuration of a server computing device according to some implementations.

FIG. 3 illustrates a representation of exemplary database portions.

FIG. 4 illustrates an exemplary list merge approach for keyword searching according to some implementations.

FIG. 5 illustrates a flowchart of an exemplary process for keyword searching according to some implementations.

FIG. 6 illustrates an exemplary KMap API processing with SQL operators according to some implementations

FIG. 7 illustrates an example of a percentage of single keyword buckets unexplored by the early termination process according to some implementations.

FIG. 8 illustrates an example of a percentage of tuples of KMap API output in single keyword buckets according to some implementations.

FIG. 9 illustrates a flowchart of an exemplary process for keyword searching with early termination according to some implementations.

FIG. 10 illustrates an example of early termination according to some implementations.

FIG. 11 illustrates a flowchart of an exemplary process for keyword searching with early termination according to some implementations.

FIG. 12 illustrates a flowchart of an exemplary process for keyword searching over multiple views with early termination according to some implementations.

FIG. 13 illustrates an exemplary computing device and functionality according to some implementations.

### DETAILED DESCRIPTION

The following detailed description provides various exemplary implementations, as described below and as illustrated in the drawings, this disclosure is not limited to the implementations described and illustrated herein, but can extend to other implementations, as would be known or as would become known to those skilled in the art. Reference in the specification to “one implementation”, “this implementation”, “these implementations” or “some implementations” means that a particular feature, structure, or characteristic described in connection with the implementations is included in at least one implementation, and the appearances of these phrases in various places in the specification are not necessarily all referring to the same implementation. Additionally, in the description, numerous specific details are set forth in order to provide a thorough disclosure. However, it will be apparent to one of ordinary skill in the art that these specific details may not all be needed in all implementations. In other circumstances, well-known structures, materials, circuits, processes and interfaces have not been described in detail, and/or may be illustrated in block diagram form, so as to not unnecessarily obscure the disclosure.

### Overview

Implementations disclosed herein support ranked keyword searching over views by efficiently checking Boolean expressions of keywords over view tuples and by taking advantage of the proposition that, in most scenarios, the user is only interested in one or the top several most relevant results. Thus, implementations herein provide for efficient keyword searching of logical entities based on views or queries defined in a database for retrieval of the top K most relevant view tuples for a given keyword search query (where “K” is the number of most relevant results that are returned in response to a search query, referred to hereafter as the “top K” tuples).

Some implementations include a broad class of views involving “select”, “project”, “join” and “group by” (SPJG) operators, and enable effective retrieval of the top K tuples. Further, implementations herein (1) support keyword queries involving Boolean expressions (e.g., with AND or OR or NOT operators) over keywords, (2) support a flexible relevancy scoring framework in order to measure the relevance of a particular view tuple, and (3) incur low space and maintenance overhead.

Some implementations herein retrieve from a given view the top K tuples most relevant to a keyword query by leveraging full text indexes on the base relations of the given view. Implementations also provide a syntactic construct to allow searching of a view with a single search query, without enumerating the various keyword-to-column assignments, and without issuing a large number of queries against the FTS indexes on the base relations. Thus, implementations address two main challenges for developing early termination techniques over a flexible class of scoring functions by: (1) not requiring the entire results of the FTS queries over base relations to be sorted, and (2) providing efficient processing of arbitrary Boolean expressions over query keywords.

Some implementations herein define and implement a keyword search API referred to as a “Karnaugh Map” (hereafter “KMap”), and use the KMap API to efficiently implement keyword search over views. For a keyword query on a text column of a relation, the KMap API returns tuple identifiers, relevancy scores and a bit vector. The bit vector provides information about the presence or absence of each query keyword in the attribute value of each matching tuple. The KMap API culls this information from a full text search index and uses the information to provide a response to an application or user issuing the query. Further, implementations for the KMap API may exploit the integration between keyword search engines and current database management systems.

Implementations of the KMap API provide efficient support for keyword searching over views in several ways. First, implementations of the KMap API address the problem of keyword-to-column assignment. For example, all combinations of keywords may be efficiently enumerated for each individual text column by issuing a single KMap query instead of issuing a keyword query for each combination (or one SQL query involving the union of all combinations).

Second, implementations of the KMap API enable efficient early termination techniques when only a small number of the most relevant view tuples are required (i.e., the top K). Implementations of the early termination techniques disclosed herein are more efficient than conventional techniques because they do not first sort the results of full text search queries over the base relations. Accordingly, the result from a KMap query can be naturally and efficiently grouped such that only a few, small-sized groups result in the most relevant view tuples. Thus, implementations are able to avoid processing tuples which are not in these important groups without even sorting them, which is much more efficient than conventional techniques which sort the result in a decreasing score order.

Third, implementations of the KMap API are able to efficiently handle arbitrary Boolean expressions of query keywords while processing a keyword query. For example, the information returned by the KMap API enables checking of the Boolean expression without accessing the column values in the base relations. This leads to a significant performance improvement (one to two orders of magnitude) over conventional approaches that need to access the column values for queries with expressions other than OR (e.g., AND). Additionally, implementations of the KMap API enable the Boolean expression to be pushed below the joins performed for assembling view tuples. This technique exploits the bit vectors returned by the KMap API to efficiently identify base tuples that cannot lead to view tuples that satisfy the expression before performing the joins, and is significantly more efficient than conventional approaches that check the Boolean expression on the view tuples after the joins are performed.

### Exemplary System and Database

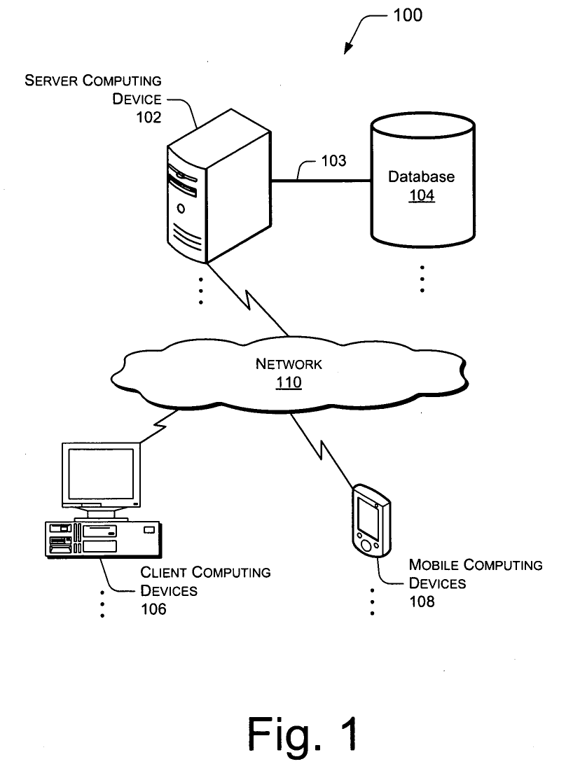

FIG. 1 illustrates one example of a system 100 for carrying out efficient keyword searching on database views. To this end, the system 100 includes a server computing device 102 in communication with a database 104 via a communication link 103. Database 104 is any type of database storing data, such as a relational database storing data related to other data and having the relationships represented through tables, matrices or other types of data structures. In some implementations, server computing device 102 and database 104 exist as a part of a data center, server farm, or the like. In other implementations, server computing device 102 is in communication with database 104 via a network as communication link 103. In some implementations, database 104 is an enterprise database accessible by server computing device 102. In some implementations, server computing device 102 and database 104 are accessible by one or more client computing devices 106 and/or mobile computing devices 108 over a network 110, for providing the data contained in database 104 to client computing devices 106 and/or mobile computing devices 108.

The system 100 can include any number of the server computing devices 102 and/or databases 104 and/or client computing devices 106 and/or mobile devices 108. For example, in one implementation, the system 100 can be the World Wide Web, including numerous databases, servers, personal computers (PCs), workstations, terminals, mobile devices and other computing devices spread throughout the world. Alternatively, in another possible implementation, the system 100 can include just a single server computing device 102 and database 104 in communication with one or more client devices 106 and/or mobile devices 108 via a LAN (local area network) or a WAN (wide area network). In some implementations, client computing devices 106 are personal computers, workstations, terminals, or the like. In some implementations, mobile computing devices are PDAs (personal digital assistants), cell phones, smartphones, laptops or other portable computing devices having data processing capability.

In the illustrated implementation, database 104 is present in one or more mass storage devices associated with server computing device 102 so that communication link 103 is an internal bus. In some implementations, database 104 is stored in a separate storage array comprising one or more hard disk drives or other mass storage devices, such as in a network attached storage device or storage area network. Furthermore, the information contained in database 104 may be accessible by client computing devices 106 and/or mobile devices 108 through the network 110 using one or more protocols, for example, a transmission control protocol running over Internet protocol (TCP/IP), or other suitable protocols.

The client computing devices 106 can be coupled to each other, to mobile computing devices 108, and/or to the server computing device 102 in various combinations through a wired and/or wireless network, including a LAN, WAN, or any other networking technology known in the art. In addition, database 104 may be stored at a single location, such as at a single mass storage device, or may be stored over a number of external sources spread over the entire network. Furthermore, while a particular exemplary architecture is illustrated in FIG. 1, it should be understood that other suitable architectures may also be used, and that implementations herein are not limited to any particular architecture.

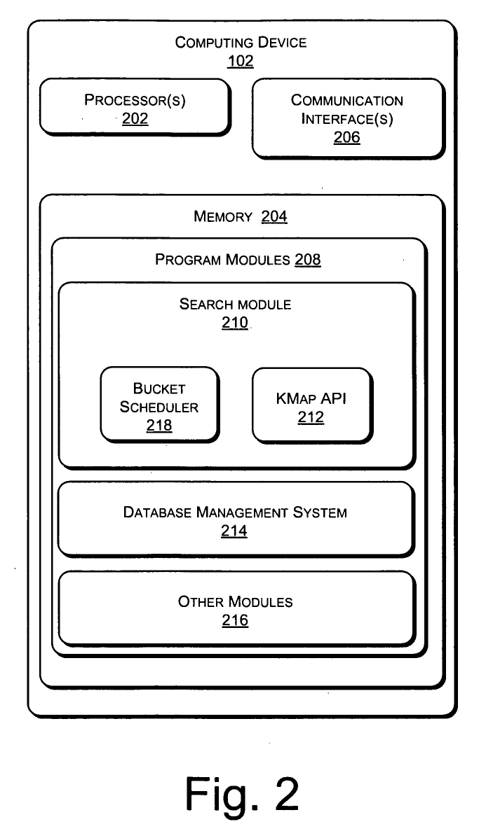

FIG. 2 illustrates an exemplary server computing device 102 on which keyword searching on views can be implemented. It is to be appreciated, that implementations of the keyword searching on views may also or alternatively be performed on other computing devices, such as client computing devices 106 or mobile computing devices 108 through incorporation of the modules described herein in those devices. In the illustrated example, server computing device 102 includes one or more processors 202, a memory 204, and one or more communication interfaces 206. The processor(s) 202 can be a single processing unit or a number of processing units, all of which could include multiple computing units. The processor(s) 202 may be implemented as one or more microprocessors, microcomputers, microcontrollers, digital signal processors, central processing units, state machines, logic circuitries, and/or any devices that manipulate signals based on operational instructions. Among other capabilities, the processor(s) 202 can be configured to fetch and execute computer-readable instructions stored in the memory 204.

The memory 204 can include any computer-readable storage medium known in the art including, for example, volatile memory (e.g. RAM) and/or non-volatile memory (e.g., flash, etc.), mass storage devices, such as hard disk drives, solid state drives, removable media, including external and removable drives, or the like. The memory 204 stores processor-executable program instructions or code that can be executed by the processor(s) 202 for carrying out the methods and functions described herein.

The communication interface(s) 206 facilitate communication between the server computing device 102 and database 104 and/or client computing devices 106 and/or mobile computing devices 108. Furthermore, the communication interface(s) 206 may include one or more ports for connecting a number of client-computing devices 106 to the server computing device 102. The communication interface(s) 206 can facilitate communications within a wide variety of networks and protocol types, including wired networks (e.g., LAN, cable, etc.) and wireless networks (e.g. WLAN, cellular, satellite, etc.). In one implementation, the server computing device 102 can receive input query from a user or client via ports connected through the communication interface(s) 206 and the server computing device 102 can send back the retrieved relevant information back to the client computing device via the communication interface(s) 206.

Memory 204 includes a plurality of program modules 208 stored therein and executable by processor(s) 202 for carrying out implementations herein. Program modules 208 include a search module 210 including a KMap API 212, described in additional detail below. Memory 204 may also include a database management system (DBMS) 214 and other modules 216, such as an operating system, communication software, drivers, and the like. In some implementations, DBMS 214 is Microsoft SQL Server®, Oracle® Database 11g, or other suitable database management software. Search module 210 may also include a bucket scheduler 218 for use in carrying out an early termination process, as described below.

In some implementations, server computing device 102 receives a keyword query from a user or an application, and processors 202 execute the keyword query on the database 104. In other implementations, client computing device 106 or mobile computing device 108 include processors 202 and memory 204, along with program modules 208 and search module 210. In these implementations, client computing device 106 or mobile computing device 108 receives the keyword query and executes search module 210. In this situation, server computing device 102 acts as a database management server for enabling access to the database by the client computing device 106 or mobile computing device 108. Further, while exemplary system architectures have been described, it will be appreciated that other implementations are not limited to the particular system architectures described herein.

### Exemplary Database Representation for Discussion

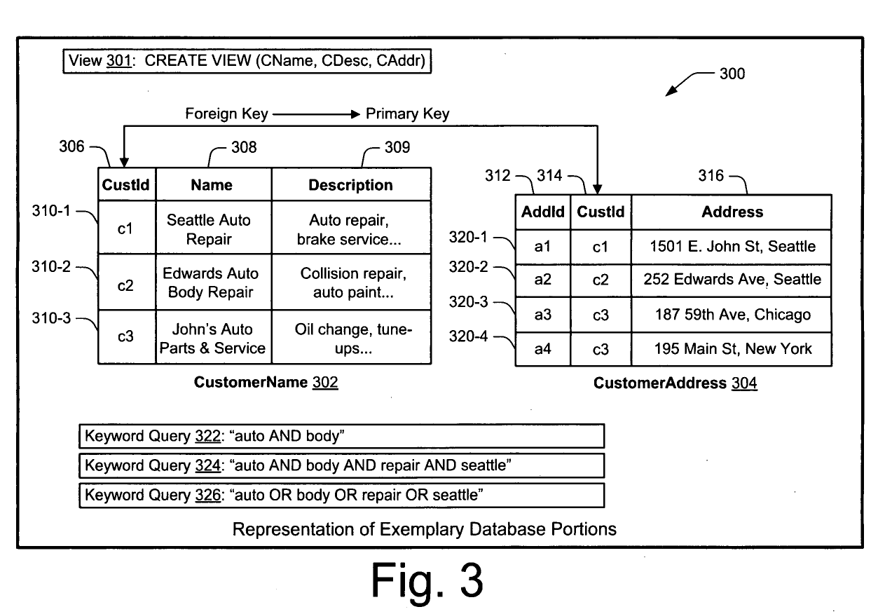

FIG. 3 illustrates a representation of exemplary portions of a database 300 for generating a view. The representation of database 300 includes a CustomerName base relation 302 taken from a first portion or table of database 300, and a CustomerAddress base relation 304 taken from a second portion or table of database 300. A view 301 is virtually created from the two relations 302, 304 using a “join” function without having to materialize an actual table in the database 300, for example, by the following commands:

CREATE VIEW CustView(CName,CDesc,CAddr)
AS
SELECT CName.Name, CName.Desc, CAddress.Addr
FROM CName, CAddress,
WHERE CName.CustId = CAddress.CustIds.

In this example, CustomerName relation 302 includes a Customer ID column 306, a customer Name column 308, and a customer Description column 309. Rows 310-1 through 310-3 contain examples of corresponding customer IDs, names and descriptions. CustomerAddress relation 304 includes an Address ID column 312, a Customer ID column 314, and an Address column 316. Rows 320-1 through 320-4 contain corresponding address IDs, customer IDs, and addresses. Keyword queries, such as queries 322, 324, 326 may be applied to search for information in the view represented.

As an example, given a keyword query 322 such as ‘auto AND body’ on the Name column 308 of the CustomerName relation 302, a conventional FTS system would be able to return the relevant tuple identifiers (corresponding to the information of row 310-2 in this case) along with a relevancy score indicating the degree of match. However, in general, information about entities or real world objects is fragmented across multiple relations in a database, as illustrated in FIG. 3. Consequently, there often may not be a single tuple in a database relation that contains all query keywords.

As another example, the keyword query 324 ‘auto AND body AND repair AND seattle’ is applied to the database representation 300 in FIG. 3, such as for attempting to locate information about an auto body repair shop in Seattle. In this example, related tuples from different relations are joined through primary key-foreign key relationships, such that the joined tuple contains all the keywords. In this example, no single base tuple in either of the two base relations 302, 304 contains all the query keywords, but the joined tuple c2(join)a2 does contain all of these keywords. The joined view tuple represents logically meaningful information units containing name, description and address information of individual customers. The goal of keyword searching on databases is to return such relevant joined view tuples that match a posited query. Therefore, enabling keyword search over individual columns (or even individual relations) only, as is done by current commercial FTS engines, is often inadequate for truly enabling keyword searching on relational databases.

Often, the goal of a keyword search is to return the top K most relevant view tuples for a keyword query. Some implementations focus on a broad class of SPJG views involving “select”, “project”, “join”, and “group by” operators and on a class of “monotone” scoring functions. Further, some implementations describe techniques for the class of SPJ views consisting only of selections, projections and joins.

As an example, let V be a view involving select, project, join (SPJ) operations defined over a set of base relations {R₁, R₂, . . . , Rₘ. For example, the view CustView generated with reference to FIG. 3 consists of a primary key-foreign key join between the base relations CustomerName 302 and CustomerAddress 304.

Each view tuple vεV is therefore a joined tuple obtained by joining one tuple tᵢεRᵢ from each base relation Rᵢ. These tuples tᵢ are referred to as the base tuples of the view tuple v. Thus, the base tuple tᵢ “participates” in the view tuple v. For example, the view tuple c1 (join) a1 consists of two base tuples c1εCustomerName and a1εCustomerAddress. Further, each of the keyword searchable columns V₁, . . . , Vₘ in V is derived from a column of a base relation in the view. For example, the three text columns Name, Description and Address of the view in FIG. 3 corresponds to the columns Name 308 of base relation CustomerName 302, Description 309 of base relation CustomerName 302, and Address 316 of base relation CustomerAddress 304.

It should be noted that a column of a base relation is considered “searchable” if an FTS query can be performed on the column, i.e., an FTS index has been built on the column. Thus, a column A of a SPJ view V is searchable if and only if the column corresponds to a searchable column C of one of the base relations Rᵢ, i.e., the column value v[A] of any view tuple vεV is equal to the column value tᵢ[C] of its base tuple tᵢεRᵢ in Rᵢ. The columns CName, CDesc and CAddr of the above view are all searchable columns as they correspond to searchable base relation columns CName.Name 308, CName.Desc 309 and CAddress.Addr 316, respectively.

### Ranked Boolean Keyword Search Over Views

Users or applications may specify Boolean expressions using keywords that result view tuples from the view V must satisfy. For example, the keyword query Q w₁ AND w₂ AND . . . AND wₙ requires that any view tuples in the result contain all the query keywords. The keyword query Q w₁ OR w₂ OR . . . OR wₙ requires that view tuples in the result contain at least one of the query keywords. Whenever it is clear from the context, Q is used to loosely denote the set of keywords in a query Q. Thus, a view tuple vεV satisfies a Boolean keyword query Q for a set A of searchable columns of V if the string Concat_{A}ε_{A}v[A] formed by concatenating the values of V in the specified columns A (with a space between the column values) satisfies the Boolean query. For example, consider the Boolean keyword query 324 ‘auto AND body AND repair AND seattle’ on the view in the example of FIG. 3. For the searchable columns CName, CDesc, CAddr, the view tuple c1 (join) a1 in FIG. 3 does not satisfy the Boolean keyword query as the concatenation of the text column values does not contain all the keywords. On the other hand, the view tuple c2 (join) a2 does satisfy the Boolean keyword query.

In implementations herein, a scoring function compares a view tuple v with a keyword query Q and returns a real number as a relevancy score. The class of scoring functions considered herein “combines” the relevancy scores of comparing Q with one or more searchable column values v[A] of the view tuple. In the scoring framework herein, the comparison between a searchable column value v[A] and Q has two scoring factors.

The first scoring factor is a keyword match factor that may be a conventional keyword scoring factor, such as the tf-idf (term frequency-inverse document frequency) weight, the Okapi BM25 ranking function, or a similar ranking method computed by most conventional FTS engines for comparing the keywords in the query Q with those in the column value v[A]. As mentioned above, column value v[A] is equal to the column value tᵢ[Cᵢ] of the base tuple tᵢ in the relation Rᵢ. Let kwds(Q) denote the set of keywords in the Boolean keyword query Q. Let OR(S) denote the Boolean keyword query constructed by taking the OR of the set S of keywords. Then, it may be assumed that the keyword match score of v[A] is the same as the score FTScore(tᵢ[C];OR(kwds(Q))) returned for tᵢ[C] by an FTS engine for the OR query OR(kwds(Q)) over the corresponding base relation column Rᵢ.C.

The second relevancy scoring factor measures keyword co-occurrence in v[A], and can be referred to as the column co-occurrence factor. For example, two view tuples might have equal keyword match scores but the one where multiple keywords occur together in fewer (important) columns is often more relevant. Consider the query ‘john AND auto AND service’ on the view in the example of FIG. 3. Both view tuples v1=c1 (join) a1 and v2=c3 (join) a3 in FIG. 3 satisfy the query. Consequently, if the IDF weights of the query keywords are similar in the various columns, both view tuples will have similar keyword match scores. However, by scoring the view tuples that have more keywords in the same column values to have a higher value (e.g., v2) than those with keywords in different column values (e.g., v1), the co-occurrence factor captures the natural intuition that v2 is a better match in this case. The formula (1+ln(|Q∩v[A]|)) is used as the co-occurrence factor where |Q∩v[A]| denotes the number of keywords occurring in both Q and the tokenized column value vᵢ. Therefore, the second relevancy scoring factor score Score(v[A], Q) is defined for the column value v[A] with respect to Q as FTScore(tᵢ[C], OR(kwds(Q)))×(1+ln(|Q∩v[A]|)).

The overall relevancy score Score_{Combine}(v, A, Q) of a view tuple v for a Boolean keyword query Q, a set of searchable columns A of the view and a combination function Combine is defined as follows:

Score_{Combine}(v,A,Q)=Combine_{A}ε_{A}(Score(v[A],Q)

This assumes Combine is a monotone function which takes a vector of non-negative real numbers and returns a non-negative real number. A function ƒ is said to be monotone if ƒ(u₁, . . . , uₘ)≧ƒ(v₁, . . . , vₘ) whenever uᵢ≧vᵢ for each i, i=[1, m].

The problem of ranked Boolean keyword search over views can be defined as follows: Given (i) the view V to search; (ii) the set A of searchable columns of V to search on; (iii) the Boolean keyword query Q; (iv) the number K of view tuples desired; and (v) a monotone function Combine to combine the scores of the individual column values in A, the goal of ranked Boolean keyword search is to return at most K tuples of V such that each of them satisfies the Boolean keyword query Q and any tuple v in the returned set has a score Score_{Combine}(v, A, Q) greater than or equal to the score Score_{Combine}(v′, A, Q) of any remaining view tuple v′ which satisfies Q. In other words, any view tuple in the returned set will have a score greater than or equal to those of the remaining view tuples which satisfy the query Q that are not part of the returned set.

### FTSView Syntax

Ranked Boolean keyword queries cannot be elegantly expressed in SQL conventionally. For example, in conventional approaches, users are forced to specify the keyword-to-column assignments. Implementations herein incorporate a novel FTSView syntax that relieves the user from that requirement and allows the user to search a view by providing a single search query. A table valued function FTSView(V, A, Q, K, Combine) is defined herein that takes the same arguments as the ranked Boolean keyword search problem as defined above. The Combine function can be expressed as a scalar expression involving weights on the columns in A and scores for those columns. FTSView returns the results of ranked Boolean keyword search for those inputs.

For example, the top 10 tuples of the view 301 defined in the example of FIG. 3 can be obtained for satisfying the Boolean query ‘auto AND body AND repair AND seattle’ using FTSView as follows:
Select*from FTSView(CustView, {CName, CDesc, CAddr}, ‘auto AND body AND repair AND seattle’, 10, 2*Score(CName)+Score(CDesc)+Score(CAddr))

All the three searchable columns of the view are considered for this query. Further, some columns are specified to be more important than others. In this example, the name column 308 CName is specified to be twice as important as the description column 309 CDesc and the address column 316 CAddr. Thus, weighting factors (in this case “2”) can be applied to the scores of one or more columns for specifying relative levels of importance of the keyword query to each columns

### KMap API

In this section, the KMap API 212 that makes up part of the search module 210 is described further. The KMap API 212 is a search API developed and applied by implementations herein, and is referred to the KMap API due to its being loosely based on the Karnaugh Map from Boolean algebra. Implementations of the KMap API disclosed herein are used to support keyword search on views efficiently. The KMap API may be used for keyword searching over individual text columns for returning additional information about the presence of each query keyword in the column value of each matching tuple.

For example, consider a Boolean query Q over keywords w₁, w₂, . . . wₙ (e.g., (w₁ OR w₂ . . . OR wₙ) and (w₁ AND w₂ . . . AND wₙ)). The KMap API query KMap(R.C, Q) for a Boolean query expression Q on a text column C of a relation R returns the identifiers (ids) of each tuple t of R whose column value t[C] satisfies the query Q. In addition, for each such tuple identifier t that is returned, the KMap API also returns a bit vector bv(t[C], Q) of a length n equal to the number of keywords, and bit locations corresponding to the order of the keywords, such that the i^{th} bit of bit vector bv(t[C],Q) is “1” if the keyword wᵢ is present in t[C], and “0” otherwise. For example, in a query having four keywords, w₁, w₂, w₃ and w₄, then if all the keywords are present in a particular returned tuple, the bit vector for that tuple would be [1111], whereas if only the first two keywords w₁, w₂, are present in the particular tuple, and w₃, w₄ are absent, then the bit vector would be [1100], and so forth, so that there is a one-to-one matching correspondence between each of the bit positions in the bit vector and one of the keywords in the search query according to the order of the words.

The KMap query also returns a score for each tuple t using the following equation:

Score(t[C],Q)=(1+ln(NumBitsSet(bv(t[C],Q))))×ΣᵢFTScore(t[C],wᵢ).

Thus, the output results of the KMap API for each tuple identified as having one or more matching keywords may be represented as
(tuple identifier, [bit vector], score).

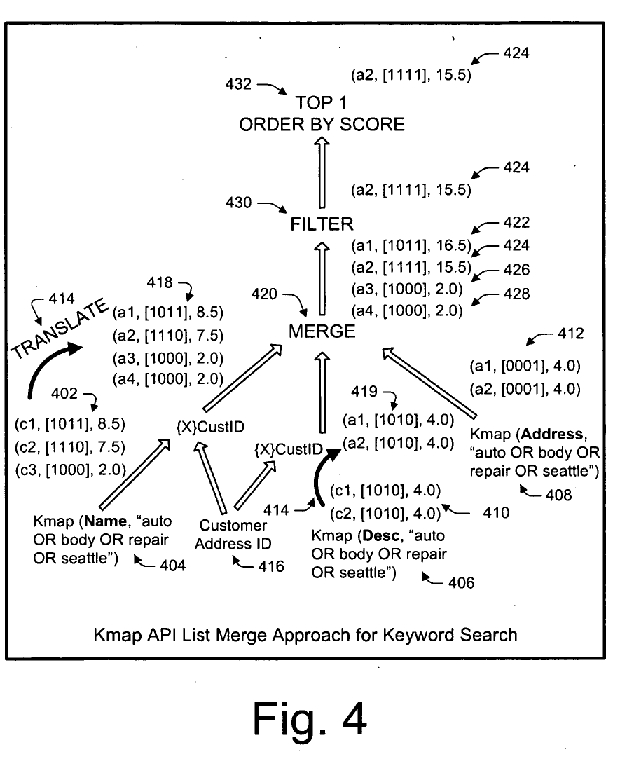

FIG. 4 illustrates an example of keyword searching achieved using the KMap API discussed above. This example, is based on the example of FIG. 3 using Boolean keyword query 326 ‘auto OR body OR repair OR seattle’ on the view of FIG. 3. For example, when applying the KMap API to the text column Name 308 of the CustomerName relation 302 in FIG. 3, the matching tuples are c1, c2 and c3. For c1, the bit vector is [1011] since the first, third and fourth keywords, “auto”, “repair” and “seattle” are present, but the second keyword “body” is not present. Similarly, the bit vector for c2 is [1110] since the first, second and third keywords, “auto”, “body” and “repair” are present, but the fourth keyword, “seattle” is not present. Additionally, the bit vector for c3 is [11000] since only the first word “auto” is present in Name column 308.

Next, suppose the FTS scores calculated for the three base tuples c1, c2 and c3 are 4.0, 3.5 and 2.0, respectively (i.e., the respective scores calculated using the first keyword match factor discussed above, such as tf-idf). Then, the column co-occurrence score is calculated for c1 as (1+ln(3)), so the overall score for c1 is (1+ln(3))×4=8.5. The column co-occurrence score for c2 is (1+ln(3)), so the overall score for c2 is (1+ln(3))×3.5=7.5. The column co-occurrence score for c3 is (1+ln(1)), so the overall score for c3 is (1+ln(1))×2=2.0. As a result, applying the keyword query 326 on the Name column 308 with the KMap API: KMap(CustomerName.Name, ‘auto OR body OR repair OR seattle’) returns the results{(c1, [1011], 8.5), (c2, [1110], 6.0), (c3, [1000], 2.0)} as shown in FIG. 4 at reference numeral 402.

Some implementations herein rely on the KMap API for OR queries over keywords in order to support Boolean semantics (such as AND and OR semantics) on views. The terms KMap API and KMap query are used interchangeably. As another example, referring to FIG. 4, suppose it was desired to execute the keyword query 324 (“auto AND body AND repair AND seattle”) on the view 301 generated from representation 300 of FIG. 3. The KMap query is applied to each text column, i.e., name 308, description 309, and address 316 as an OR query rather than as an AND query, as illustrated in FIG. 4 as KMap queries 404, 406, and 408 respectively. These queries 404, 406, 408 produce KMap results 402, 410 and 412 respectively. Thus, the results 402 for KMap query 404 on name column 308 produce information for three relevant tuples c1, c2 and c3. Similarly, the results 410 for the KMap query 406 on description column 309 produce information for two relevant tuples, c1 and c2, and the results 412 for the KMap query 408 on the address column 316 produce information for two relevant tuples a1 and a2. Thus, each of the results 402, 410 and 412 includes a bit vector and a score for the corresponding tuple identifiers.

Next, in order to achieve the Boolean AND function desired by the original keyword query 324, it is necessary to carry out a merge function on the results of the original KMap queries on the columns. However, before the merge may be carried out it is necessary to correlate the results 402 and 410 with the results 412 using the same tuple identifiers. This translation of identifiers is carried out using primary key-foreign key correlation, for example both the CustomerName relation 302 and the CustomerAddress relation 304 include a customer ID 306, 314 that may be used in a primary key-foreign key correlation in order to translate the tuples from the CustomerName relation 302 to the CustomerAddress relation 304. Accordingly, as illustrated at 414, translation is carried out using the customer address ID 416 to achieve translated results 418, 419. It should be noted that since customer ID c3 corresponds to both address IDs a3 and a4 in the CustomerAddress relation 304, the translation of the results for c3 produces two results, one for a3 and another for a4.

Of course, translation is not always necessary, but after all the result tuples 418, 419, and 412 are able to be correlated with one another by having the same identifier type used, the merge process 420 may be carried out. During the merge process, for each identifier that is the same, the bit vectors and scores are combined. For example, address ID a1 is merged to produce the merged results 422 for address ID a1 having a bit vector of [1011] and a total score of 16.5 by combining the results of a1 from results 418, 419 and 412. It may be seen that the merged score is achieved by summation of the scores of each result in 418, 419 and 412, and that the merged bit vector is achieved by including a “1” at any location that has a “1” in any of the results 418, 419 or 412. The merged results for address ID a2, a3 and a4 are also shown as merged results 424, 426 and 428, respectively.

Following the merge 420, a filter process 430 is carried out. Because the original query used all AND operators, only those results in which the bitmap is all “1s” are relevant. Accordingly, the filter process eliminates results 422 and 426 from consideration leaving filtered and merged results 424. Finally, if there are more than one set of results remaining, the remaining results are sorted according to highest score and returned as top results 432. In this example, output results 424 for address ID a2 are returned as the relevant tuple in response to the original keyword query 324.

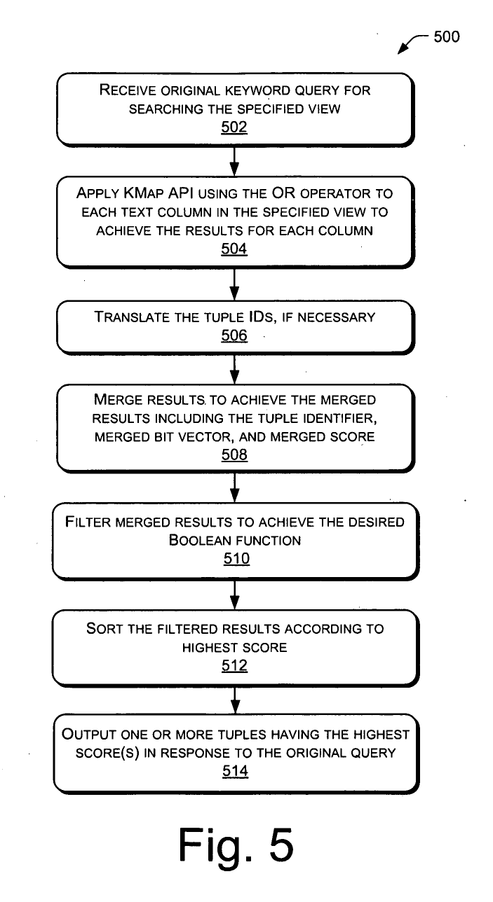

FIG. 5 illustrates a flow chart of an exemplary process 500 according to implementations described above with reference to FIG. 4. This process may be carried out by processors 202 executing the search module 210 and the KMap API 212.

At block 502, the original keyword query is received for searching the specified view.

At block 504, the KMap API is applied using the OR operator to each of the text columns in the specified view to achieve the results for each column including tuple identifier, bit vector and score.

At block 506, translation of the tuple IDs for the results is carried out, if necessary, to enable the results from the various columns to be correlated and merged.

At block 508, the results of blocks 504 and 506 (if applicable) are merged to achieve the merged results including the tuple identifier, merged bit vector, and merged score.

At block 510, the merged results of block 508 are filtered to achieve the desired Boolean function. For example, in the case of an AND function, both keywords on each side of the AND operator must be present, and therefore “1s” must be included in the bit vector for both of the corresponding locations; however, in the case of an OR operator, a “1” must be located in at least one of the corresponding locations.

At block 512, the filtered results are sorted according to highest score.

At block 514, one or more tuples having the highest scores are output in response to the original query. For example, the top five tuples may be output or, as another example, a single tuple having the single highest score may be output.

### Implementations of KMap API

In some implementations, the KMap API may be implemented on top of DBMS 214 (e.g., as a SQL stored procedure or a CLR function). In such an implementation, an FTS index may be built on each of the relevant text columns in the base relations. FTS indexes are inverted indexes built over all values in a column. For each keyword occurring in a value, the index maintains a list of IDs of all tuples whose column values contain the keyword.

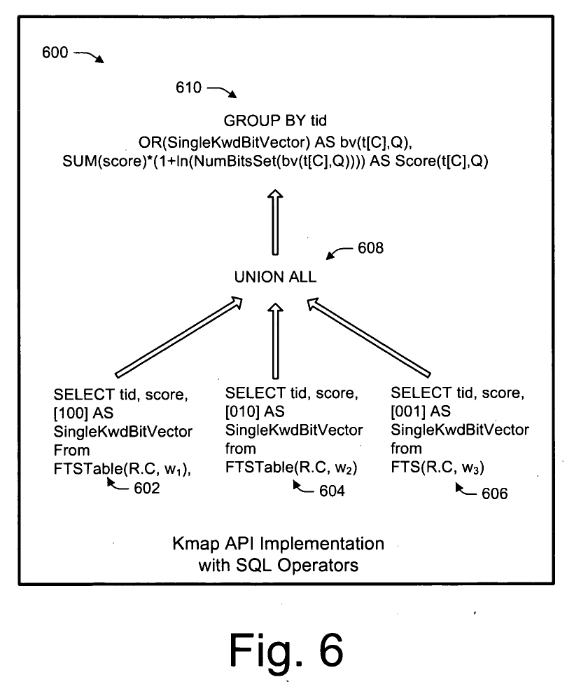

SQL Implementation: This implementation effectively exploits the integration between the FTS engine and an SQL engine. The SQL execution plan for implementing an example KMap query 500, KMap(C, ‘w1 OR w2 OR w3’) is illustrated in FIG. 6.

In this example, given a query Q=w₁ OR . . . OR wₙ, a keyword query FTS(C,wᵢ) is issued to full text search for each keyword wᵢ which returns IDs of tuples t and scores FTScore(C, t[C],wᵢ) whenever column value t[C] contains wᵢ. For each tuple id in the output of FTS query FTS(C,wᵢ), a bit vector bv(t[C],wᵢ) is included that encodes the matching keyword, i.e., a bit vector of length n with only the ith bit set to 1, as represented in FIG. 6, by first results 602 for first keyword w1, second results 604 for second keyword w2, and third results 606 for third keyword w3. The results are Unioned using a Union All command 608 and then grouped by tuple id at 610 using a Group By command. (Note that alternatively a full outer join of the results of FTS queries on tuple id may be made instead of Union All followed by Group By. The union all-group by implementation has been found to be more efficient since the full outer join needs to hash intermediate join results in addition to the original FTS outputs.) For each tuple, the bit vector and score are computed as follows:

Bit Vector: bv(t[C],Q) for t[C]: to obtain a bit vector bv(t[C],Q) to encode the keywords t[C] contains by applying a bitwise OR over the bit vectors bv(t[C],wᵢ) obtained above from the FTS queries for each keyword.

Score: Score(t[C],Q): The FTS scores FTScore(C, t[C],wᵢ) are combined using SUM and the result multiplied with (1+ln(|Q∩v[A]|)) to obtain the overall score for each tuple. As discussed above, |t[C]∩Q)|=NumBitsSet(bv(t[C],Q))), where NumBitsSet(bv(t[C],Q)) denotes the number of bits set to 1 in the bit vector bv(t[C],Q). Thus, the score is (1+ln(NumBitsSet(bv(t[C], Q))))×Σᵢ FTScore(t[C], wᵢ).

Server Implementation: efficiency can also be improved in some implementations if the KMap API is implemented natively inside the FTS engine. FTS engines typically use the document-at-a-time (DAAT) query evaluation model where the tuple ids that match with the query are obtained via a zigzag join of the posting lists of the keywords. Due to the way the cursors move in a zigzag join, it is possible to output the complete bit vector and the score for each tuple id during the zigzag join. This implementation can be efficient since it does not have any additional grouping cost incurred by the SQL implementation. Some implementations described herein use the integrated SQL implementation. Since the techniques discussed below are independent of the particular KMap API implementation, a more efficient native implementation may be implemented if available.

### Top-K Keyword Search on Views

Some implementations focus on returning the top K tuples of a given view by only taking into account the set of keywords kwds(Q) in the query, i.e., ignoring the Boolean expression. Current techniques for top-K keyword search on views are inefficient because they either (i) do not attempt to terminate early or (ii) terminate early but still need to sort the results of OR queries OR(kwds(Q)) posed against the base text columns. Implementations disclosed herein are able to terminate early without sorting all the keyword search results from the base columns.

### Early Termination

Implementations herein use the bit vector returned by KMap API to terminate processing early without requiring sorting the entire output. For each searchable column AεA specified in the FTSView query, a KMap query is issued on the corresponding base relation column. The KMap API returns the same set of tuples as the OR query, but also includes the extra bit vector column. The tuples are then partitioned in the KMap output into “buckets” based on the bit vector, i.e., so that there is one bucket per distinct value of each bit vector. The tuples within a bucket can be in an arbitrary order. This partitioning can be performed much more efficiently than sorting the output according to score. Based on the bucketed outputs, the processing of the outputs can be terminated early, since the processing relies only on ordering among buckets (which can be determined very efficiently) and not on any ordering within a bucket. This is accomplished by working at the granularity of buckets, rather than sorting of all the outputs. Thus, implementations of the bucket-granularity early termination process are based on two characteristics of distribution of tuples in the buckets: (1) tuples in some buckets have much higher scores than other buckets; and (2) high-scoring buckets contain few tuples.

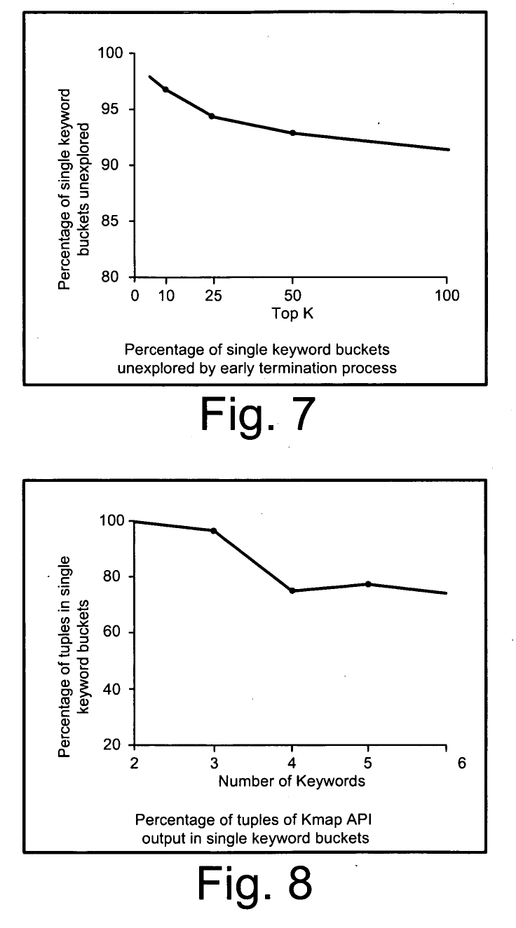

Tuples in some buckets have much higher score: The tuples in the buckets with multiple matching keywords (i.e., multiple bits set) typically have much higher score than those in the single-keyword buckets (or buckets with fewer keyword matches). This is because FTS engines typically compute (e.g., using tf-idf or BM25 ranking functions) the overall score by summing the scores for each matching keyword. The co-occurrence factor and the inverse document frequencies of the keywords also contribute to disparity of scores among the buckets. Due to this difference in scores, when multiple-keyword buckets are present, the early termination process often terminates before exploring even a single tuple in the single-keyword (or fewer-keyword) buckets. FIG. 7 illustrates the percentage of single keyword buckets unexplored by implementations of the early termination process, averaged over 100 queries running on a database containing name and address information of 20 million organizations. As illustrated in FIG. 7, over 90% of single keyword buckets are not explored by the early termination process even when top K=100. Further, these unexplored buckets contain a large percentage of the tuples in the KMap output.

High-scoring buckets contain few tuples: The early termination process will save the most cost if the multi-keyword buckets that are processed contain a small fraction of the tuples and the single keyword buckets (that are largely unexplored by the early termination process) contain the majority of the tuples. FIG. 8 illustrates the percentage of the tuples in the KMap API output that are in single keyword buckets for a particular number of keywords, again averaged over 100 queries made on the same database. As illustrated in FIG. 8, over 75% of the tuples are in single keyword buckets, even when 4-6 keywords are used. Therefore, if the “right” buckets are appropriately identified for processing, the process can terminate after processing only the small fraction of tuples in those buckets, leading to significant reduction in cost.

### Early Termination Implementations

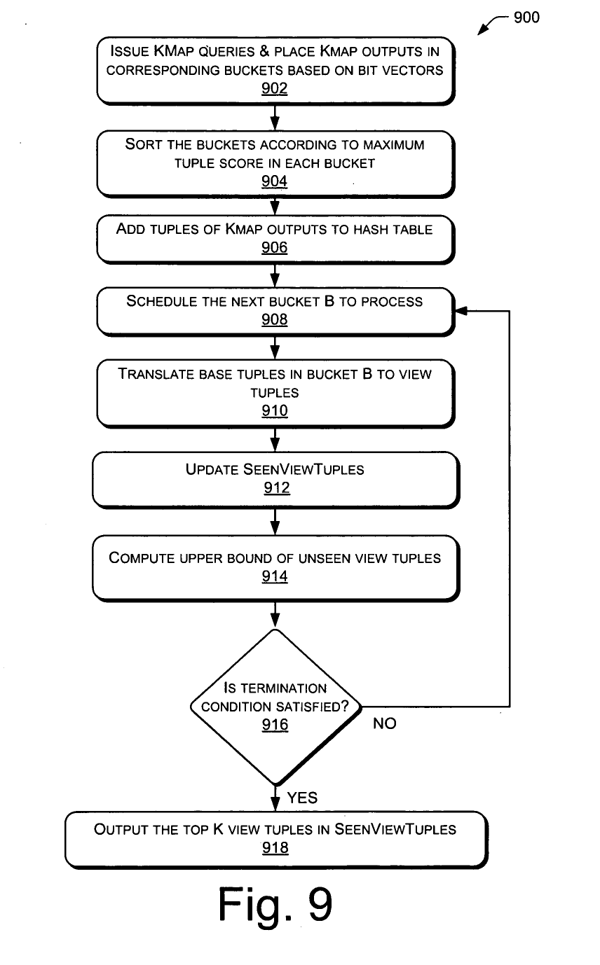

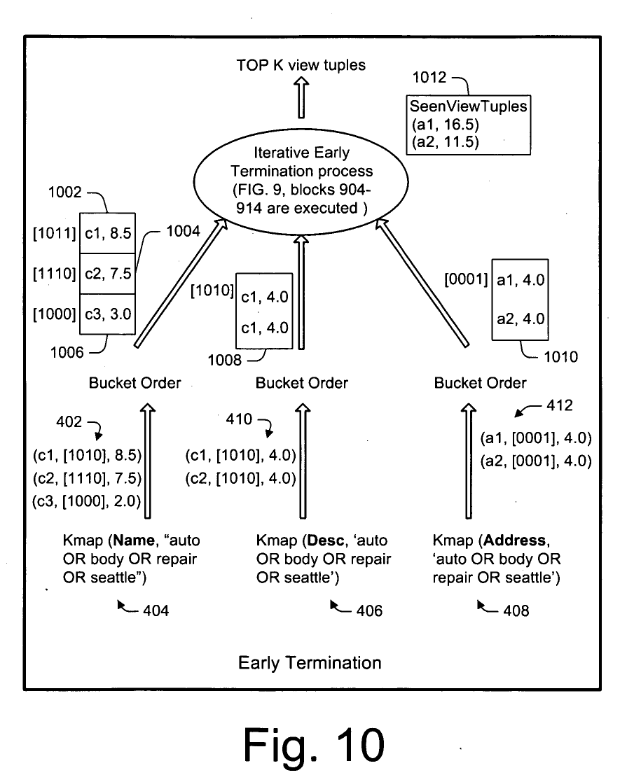

Implementations of an early termination process described herein bucket-order the KMap API outputs and exploit that ordering to terminate early. A bucket-granularity early termination (BGET) implementation described herein partitions each KMap output into buckets, orders the buckets, and exploits the inter-bucket ordering to terminate early. FIG. 9 illustrates a flow chart of an exemplary early termination process 900 for identifying the most relevant K tuples located during a keyword search carried out by the KMap API. The main differences from the threshold algorithm (TA) described above are (1) the early termination implementations herein operates at bucket-granularity instead of tuple-granularity and (2) early termination implementations herein include translation (e.g., block 906 of FIG. 9), as discussed in detail below with reference to FIG. 9. The main issues to resolve are (a) partitioning the KMap output into buckets efficiently; (b) identifying the proper buckets to process; (c) performing the translation efficiently; and (d) computing tight upper bounds. We now discuss the steps of the process in detail. The process of FIG. 9 may be carried out by processors 202 executing modules including the bucket scheduler 218 in search module 210. In some implementations, bucket scheduler 218 may be included in the KMap API 212 as middleware, or in other implementations may be a portion of the search module 210 separate from KMap API 212.

At block 902, KMap queries are issued for each text column in the base relations, as described above, and the resulting tuples are ordered according to buckets based on the bit vector returned with each of the KMap output results. Thus, for each searchable column A E A specified in the FTSView query, a KMap query KMap(Rᵢ.C, OR(kwds(Q))) is issued on the corresponding base relation column where OR(kwds(Q)) denotes the Boolean keyword query constructed by taking the OR of the query keywords in the query Q. The tuples in each KMap output are retrieved from the DBMS and partitioned or grouped into buckets based on the bit vector associated with each output. Further, when the results are stored in the bucket, the bucket scheduler keeps track of the highest score of any tuple stored each bucket. For example, as shown in FIG. 4, the bucketization of the output of KMap(CName.Name, ‘auto OR body OR repair OR seattle’) produces three buckets: buckets [1011], [1110] and [1000], each containing one tuple. As discussed above, the process exploits the characteristic that the number of buckets is small to perform the partitioning efficiently. The process can use a direct-address table D that stores a pointer to each bucket for bit vector b at D[decimalValue(b)]. The tuples from the KMap output are read and, for each tuple, the decimal value of the bit vector is computed. Then, the direct-address table D is referred to for obtaining a pointer to the bucket, and the tuple is added to the bucket. The process keeps track of the maximum score of any tuple in each bucket as tuples are added to the buckets.

At block 904, after the process finishes adding all the tuples to corresponding buckets, the process sorts the buckets based on maximum tuple score contained by each bucket. This is referred to this as bucket ordering. In the above example, the bucket ordering produces the order: [1011] (having a score of 8.5) followed by [1110] (having a score of 7.5) followed by [1000] (having a score of 2.0). In real-world situations, the cost of ordering the buckets is almost negligible compared to the tuple sorting cost since the number of buckets is much smaller than the number of tuples. For example, the number of buckets for each column searched can at most be (2ⁿ−1) where n is the number of keywords.

At block 906, the tuples of each KMap output are also added to a separate hash table (denoted by KMapOutputHT(Rᵢ.Cᵢ)), with the base tuple id used as the key, so as to be able to look up the score and bit vector of a base tuple.

At block 908, after all the outputs have been stored in buckets, one of the buckets is selected for processing by the bucket scheduler. Thus, one bucket from one of the KMap outputs is processed in each iteration of steps 908 through 914, and then a termination condition is checked at step 916. Since buckets within a KMap output are always processed in bucket-order, the task of the bucket scheduler is to determine from which KMap output to pick the next bucket. It has been determined to generally pick the bucket having the highest maximum tuple score is most productive. However, it is also necessary to consider the cost of processing a bucket, since buckets have widely different translation costs (depending on the number of tuples in the bucket). Implementations herein adopt the following approach: pick the bucket with the highest maximum tuple score; however, if there are two or more buckets with almost the same maximum tuple score (e.g., with 10% of each other), the process picks the one with the smallest size (i.e., having the fewest number of tuples stored therein).

It should be noted that the above implementation of the scheduling process does not consider Boolean expressions over query keywords while scheduling buckets for processing. However, other implementations described below provide adaptations of the scheduling process to efficiently handle Boolean expressions.

At block 910, during processing of the bucket, the base tuples may need to be translated to view tuples, to compute the complete scores of the view tuples that the base tuples of the scheduled bucket participate in. To carry out translation, the base tuple ids in the scheduled bucket are translated. As discussed above with reference to FIG. 3, the KMap API receives a keyword query and outputs ids of matching tuples of the base relations (along with bit vectors and scores). Thus, base tuple-to-view tuple translation may be defined as follows: Given the id of a base tuple (or a set of base tuples) from a relation, return the base tuple id set of each view tuple that the given base tuple(s) participates in. This step is referred to as base tuple-to-view tuple translation, or simply translation.

The process implements this translation by first inserting the ids of the tuples in the scheduled bucket into a temporary relation Temp(Id). The process then issues an SQL query, referred to as translation query, to the DBMS. The disclosure first discusses the translation query for the general class of SPJ views and then presents an optimization for key-foreign key join views.

SPJ views: The idea is to project out the id columns of the view tuples while restricting the view tuples to those whose base tuple from R_{sch} appears in Temp. Let R_{sch} denote the base relation the scheduled bucket belongs to. Let J denote the join and selection conditions in the view definition. Let Rᵢ.Id denote the id column of the base relation Rᵢ. The following SQL query performs the desired translation:

SELECT R₁.Id, ... , Rₘ.Id
FROM R₁, ... ,Rₘ, Temp
WHERE J
and R_{sch}.Id = Temp.Id

Key-foreign key join views: Suppose all joins in the view are key-foreign key joins. First consider the case where there are no selection conditions. The process can reduce the number of joins in the translation query based on the following insight: if a base relation Rᵢ does not have a foreign key column that references the primary key of another base relation, there must be another relation Rⱼ, j≠i that has a foreign key column, denoted by FK(Rᵢ), that references the primary key of Rᵢ. In this case, the process does not need to join with Rᵢ since (1) the process can obtain the base tuple ids of Rᵢ from FK(Rᵢ) in Rⱼ and (2) the process does not need Rᵢ to perform any other joins. Hence, the process only joins the relations having foreign key columns that reference the primary key of other base relations of the view.

As an example, consider the key-foreign key join view of FIG. 3. The base relation CName does not have a foreign key column and hence can be eliminated. The process obtains the base tuple ids of CName from CAddress.CustId. If the scheduled bucket belongs to CName, the translation query is

SELECT CAddress.CustId, CAddress.AddId
FROM CAddress, Temp
WHERE CAddress.CustId = Temp.Id

If the scheduled bucket belongs to CAddress, the translation query is

SELECT CAddress.CustId, CAddress.AddId
FROM CAddress, Temp
WHERE CAddress.AddId = Temp.Id

Formally, let F⊂{R₁, . . . , Rₘ} denote the set of relations having foreign key columns that reference the primary key of other base relations of the view. Let J denote the subset of join conditions involving only the relations in F. Let FK(Rᵢ) denote the foreign key column referencing the primary key column of Rᵢ if there is one, and Rᵢ.Id otherwise. The following SQL query performs the desired translation:

SELECT FK(R₁), ... , FK(Rₘ)
FROM F, Temp
WHERE J
and FK(R_{sch}) = Temp.Id

If there are selection conditions in the view, those relations are also included in the FROM clause and all the join/selection conditions involving those relations are included in the WHERE clause. A common case of a key-foreign key join view is where a central fact table joins with multiple dimension tables. The central fact table contains all the foreign keys referencing the primary keys of the dimension tables and the joins are on those columns. In this case (assuming there are no selections), the process joins Temp with only the fact table.

At block 912, another hash table, or other suitable data structure, referred to as SeenViewTuples is maintained and is updated with the processed tuples. Thus, the early termination process maintains an in-memory hash table referred to as SeenViewTuples that contains the ids and final scores of the view tuples output by the translation step. For each view tuple id v in the output of the translation step, if v is not already present in SeenViewTuples, its final score is computed and inserted into SeenViewTuples. The computation of the final score of v requires the ids of the participating base tuples. For a column AεA corresponding to base column Rᵢ.C, the process looks up the score of its base tuple tᵢ from Rᵢ (using the base tuple ids outputted by the translation step) in the hash tables KMapOutputHT(Rᵢ.Cᵢ). If tᵢ is not present in KMapOutputHT(Rᵢ.Cᵢ), its score is 0. The process then combines the scores using Combine. Further, if a Boolean expression other than OR of query keywords is desired, it is also necessary to evaluate whether each view tuple satisfies the Boolean expression.

At block 914, the upper bound for the termination condition is determined by computing the maximum possible score of an unseen view tuple. The maximum possible score MaxUnseenScore(A) of any unseen view tuple for any column AεA is the maximum tuple score of the top unexplored bucket of KMap(Rᵢ.C, OR(kwds(Q)) where Rᵢ.C is the base column corresponding to A. This is because if it had a higher score for column AεA, the participating base tuple tᵢεRᵢ would have been in the “seen” part of the output of KMap(Rᵢ.C, Q) and hence it would have been a “seen” view tuple. Using the monotonicity property of Combine, the upper bound score UnseenUB of an unseen view tuple is Combine_{A}ε_{A}MaxUnseenScore(A).

At block 916, the termination condition is checked to determine whether the termination condition is satisfied. The process will check the termination condition by selecting the top K view tuples from SeenViewTuples. If the score of the K^{th} view tuple is greater than or equal to an upper bound score UnseenUB, then the termination condition is met. Otherwise, the process returns to block 908 for processing of the next bucket.

At block 918, when the termination condition has been met, then those top K view tuples in SeenViewTuples are returned as output and the process terminates.

FIG. 10 illustrates an implementation of the early termination process carried out, such as for the example described above with reference to FIG. 3 for the keyword query ‘auto OR body OR repair OR seattle’ on the view 301 of FIG. 3. Thus, given the FTSView query FTSView(CustView, {CName, CDesc, CAddr}, ‘auto OR body OR repair OR seattle’, 1, Score(CName)+Score(CDesc)+Score(CAddr)), where CustView is the view defined in FIG. 3, the process first issues the three KMap queries and bucket-orders the outputs. The KMap queries 404, 406, 408 are issued as discussed above with reference to FIG. 4, and the outputs 402, 410, 412 are ordered and stored according to buckets based on the bit vector for each output. For example, the KMap output for KMap(CName.Name, ‘auto OR body OR repair OR seattle’), produces three buckets 1002, 1004, 1006, corresponding to bit vectors [1011], [1110] and [1000], respectively, with maximum tuple scores 8.5, 7.5 and 2.0. Similarly, applying the KMap API to the description column 309 produces one bucket 1008 corresponding to the bit vector [1010], and applying KMap API to the address column 316 produces one bucket 1010 corresponding to the bit vector [0001]. Since there are four key words in the query, there are a total of fifteen possible buckets for each text column searched. In the example of FIG. 10, only five buckets 1002-1010 are illustrated because of the small number of results in this example.

The bucket scheduler first picks the [1011] bucket of KMap on CName.Name based on maximum tuple score of 8.5, as described above with respect to block 908. The process carries out translation per block 910 and joins the tuples (c1) for CName and CDesc with CAddress, to obtain the view tuple (c1 (join) a1), and adds the view tuple with score 16.5 to SeenViewTuples 1012 as described above with respect to block 912. UnseenUB is calculated as 7.5+4.0+4.0=15.5, as described above with respect to block 914. The termination condition is determined to be satisfied since the score of 16.5 of the view tuple added to SeenViewTuples is greater than the score 15.5 calculated for the UnseenUB, and the top K for this example, is one. Since the termination condition is satisfied, the process returns the view tuple c1 (join) a1 and terminates.

Accordingly, it may be seen that the above early termination process computes the top K view tuples without requiring sorting of all the KMap outputs. It should be noted that the process can be pipelined, i.e., is able to efficiently resume outputting the next best view tuple where it left off. This feature can be exploited in searching over multiple views, as discussed further below. Furthermore, since the process is pipelined, it is possible to implement the IEnumerable interface efficiently. Hence, the process is able to support the FTSView construct inside the server by implementing it as a CLR table-valued function.

Top-K Search with Boolean Expressions

The above implementations efficiently return the top K tuples of a given view by taking into account only the set of keywords kwds(Q) in the query, i.e., ignoring the Boolean expression. Implementations herein are now extended to efficiently support arbitrary Boolean expressions (e.g., AND) over keywords. Specifically, the techniques disclosed herein do not need to either (1) fetch text column values of the base relations and parse them to check for Boolean expressions, or (2) enumerate the various K-to-C assignments. Instead, the bit vectors returned by the KMap API can be used for the base tuples to compute the bit vector of a view tuple that encodes the presence of the query keywords in the concatenation of the view tuple's text column values. For example, the bit vector of the view tuple c1 (join) a1 in the example of FIG. 3 is 1011. Subsequently, the process can directly determine whether a view tuple satisfies the Boolean query based on that bit vector. This step is incorporated efficiently into the early termination process discussed above to produce the top K view tuples that satisfies the Boolean query.

Early Termination with Boolean Expressions

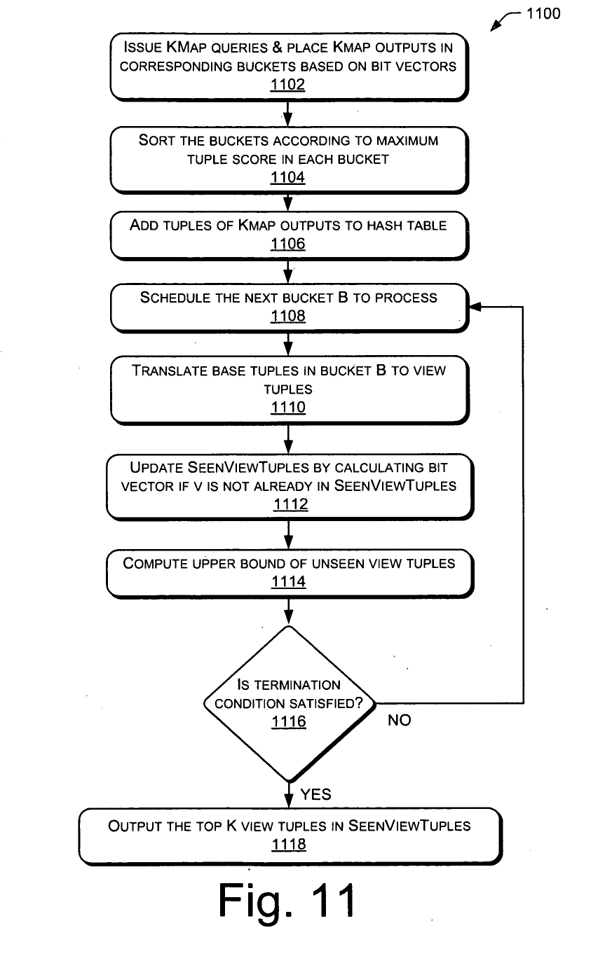

The early termination process discussed above is modified to the implementation of an early termination with Boolean expression process 1100 illustrated in FIG. 11.

At block 1102, the process issues KMap queries and places the KMap results into corresponding buckets based on bit vectors included with the results. In particular, the process issues KMap queries KMap(Rᵢ.C, OR(kwds(Q)) irrespective of the Boolean expression in Q. Recall that OR(kwds(Q)) denotes the Boolean keyword query constructed by taking the OR of the query keywords in Q. It should be noted that the process will not produce correct results if the process pushes down the Boolean expression (e.g., AND) into the FTS query on the base columns. This is because the Boolean expression is for the concatenation of the column values and the concatenated values can satisfy that expression even if none of the column values satisfy the expression. The rest of the processing of block 1102 proceeds as with block 902 described above.

At block 1104, the buckets are sorted according to the maximum tuple score in each bucket, as with block 904 discussed above.

At block 1106, the tuples of the KMap results are added to the hash table KMapOutputHT(Rᵢ.C), as in block 906, except that while populating the hash table KMapOutputHT(Rᵢ.C), the process not only adds the score of each tuple in the KMap output but also adds the bit vector returned by KMap to the hash table KMapOutputHT(Rᵢ.C).

Blocks 1108 and 1110 correspond to blocks 908 and 910, respectively, described above with respect to FIG. 9, and thus, further description is not necessary.

At block 1112, the SeenViewTuples are updated. In this implementation, for any view tuple v output by the translation step, if v is not already present in SeenViewTuples, the process first computes the bit vector of the view tuple v. The bit vector bv(v, Q) of a view tuple v is determined as follows: Consider a column AεA specified in the FTSView query. Let A correspond to the text column C of base relation Rᵢ. The bit vector bv(v(A), Q) of a view tuple v for A, which encodes the presence of the query keywords in text column value v(A), is the bit vector of tᵢ returned by KMap(Rᵢ.C, OR(kwds(Q))). The process obtains the bit vector bv(v, Q) of a view tuple v by applying a bitwise OR over the bit vectors bv(v(A), Q) of the individual columns. Since the bit vector bv(v,Q) of v encodes the presence of the query keywords in the concatenation CONCAT_{A}ε_{A} v(A) of v's text column values, v satisfies Boolean keyword query Q if and only if bv(v, Q) satisfies the same Boolean expression.

The determination as to whether the Boolean query is satisfied is made as follows: A view tuple v satisfies the Boolean keyword query Q if and only if bv(v, Q) satisfies the same Boolean expression. The process checks the Boolean expression on bv(v, Q). If the bit vector bv(v, Q) satisfies the Boolean expression, the process computes a final score for the view tuple and inserts the final score into SeenViewTuples.

Blocks 1114-1118 correspond to blocks 914-918, respectively, described above with respect to FIG. 9, and thus, further description is not necessary.

FIG. 10 illustrates an example of the process for FTSView query 324: FTSView(CustView, {CName, CDesc, CAddr}, ‘auto AND body AND repair AND seattle’, 1, Score(CName)+Score(CDesc)+Score(CAddr)). The process issues the three KMap queries and bucket-orders the outputs as shown in FIG. 10. The bucket scheduler first picks the [1011] bucket of KMap on column CName.Name based on maximum tuple score (i.e., 8.5). The process joins the tuples (only c1) with CAddress to obtain the view tuple (c1 (join) a1) and computes its bit vector ([1011] OR [1010] OR [0001]=[1011]). The bit vector does not satisfy the AND expression used in the query 324, so the process does not insert the joined view tuple into SeenViewTuples. At block 1116, it the process determines that UnseenUB is 7.5+4+4=15.5. The termination check fails, so the process go back to Step 1. The process picks the bucket having the next highest maximum scored tuple, which is the [1110] bucket of KMap on column CName.Name. The process obtains view tuple c2 (join) a2 and computes the bit vector ([1110] OR [1010] OR [0001]=[1111]). The bit vector satisfies the AND expression, so the process inserts the view tuple into SeenViewTuples (with a score 15.5). UnseenUB is 2+4+4=10. At this stage, the termination check is satisfied and the process terminates.

### Pushing Boolean Expressions Below Joins

When the FTSView query involves Boolean expressions other than OR, the process can be further optimized based on the following insight. It is possible to detect the buckets in each KMap output, just based on the bit vectors of the buckets, whose tuples cannot participate in any view tuple that satisfies the Boolean query. In other words, the process can detect such buckets before performing the translation. If the bucket scheduler schedules such a bucket, the process can save cost by not translating the tuples in the bucket and simply “skipping over” the bucket. Consider the FTSView query 324 of FIG. 3 above involving AND of all the keywords. Now, consider the [1011] bucket of KMap on CName.Name, as illustrated in FIGS. 4 and 10, and consider a base tuple in this bucket. From the bit vectors of the buckets in the other KMap outputs, it is clear that no matter which tuples in the other KMap outputs the base tuple joins with (to produce a view tuple), the bit vector of the view tuple will not be [1111] and hence cannot satisfy the AND Boolean expression of the query 324.

Let B₁; . . . ; Bₘ denote a set of buckets corresponding to the KMap outputs. Consider a bucket b of the i^{th} KMap output, i.e., bεBᵢ. Consider all combination of buckets, one from each KMap output, that includes b, i.e., B₁×Bᵢ₋₁×b×Bᵢ₊₁ . . . Bₘ where × denotes Cartesian product. The process computes the combined bit vector (using bitwise OR) of each bucket combination in the above Cartesian product and checks the Boolean expression. If there exists no combination for which the Boolean expression is satisfied, tuples in b cannot participate in any view tuple that satisfies the Boolean expression and can be skipped over. Thus, to further optimize the process, the process is modified as follows: After bucket ordering of the KMap outputs, the process considers all combinations of the buckets, one from each KMap output, i.e., B₁× . . . × . . . Bₘ. The process computes the bit vector for each combination (using bitwise OR) and retains the combinations that satisfy the Boolean expression. Subsequently, the process marks the KMap buckets that participate in at least one retained combination as viable, and the rest are marked non-viable. The process modifies the bucket scheduler block 1108 as follows: if the scheduled bucket is marked viable, the process processes the bucket. Otherwise, the process considers the bucket explored (i.e., the process moves the pointer of the top unexplored bucket to the next bucket in that KMap output) but does not actually process the bucket. Further, the process of these implementations skips block 1110 (translation) and block 1112 (update SeenViewTuples) and goes directly to block 1114 to update the upper bound score for the unseen view tuples based on the new top unexplored bucket.

As an example, consider the FTSView AND query 324 of FIG. 3. For the KMap buckets illustrated in FIG. 10, the bucket combinations are: ([1011],[1010],[0001]), ([1110],[1010],[0001]) and ([1000],[1010],[0001]). The bit vector of the combinations (joined view tuples) are [1011], [1111] and [1011], respectively. Hence the process will mark the buckets [1110] of the first KMap output, [1010] of the second KMap output and [0001] of the third KMAP output as viable and the buckets [1011] and [1000] of the first KMap output as non-viable. Therefore, the above process will avoid processing the tuples in the [1011] bucket of the first KMap output.

### Searching Over Multiple Views

The implementations described above focused on the problem of keyword searching on single view. In practice, applications may need to perform keyword search over multiple views. For example, in most real databases, such as a CRM, there are multiple logical entities types. In some scenarios, users might want to search over multiple entity collections (e.g., customer, order and contract entities) and identify the top K most relevant entities from the union of those collections. The implementations for ranked Boolean search on a single view described above can be used as a building block for conducting ranked Boolean searching over multiple views. Experiments by the inventors herein show that the one to two orders of magnitude performance gains that are obtained for the single view case also carry over to implementations of the multiple view case as well. Implementations for searching over multiple views first dynamically generates the views to search and then carries out a search of those views.

Scoring Framework: While ranking tuples from different views with different sizes (i.e., number of base relations) and structure, it is necessary to normalize the scores of the view tuples by the size of the view. The score can be defined as Score_{Combine}(v, A, Q) of a view tuple vεV as {Combine_{A}ε_{A}(Score(v(A),Q)}/Size(V).

Keyword searching over multiple views can be expressed as follows: Given a set of views {V₁, . . . , Vₗ}, a Boolean query Q, and the number K of results desired, the goal is to return at most the top K view tuples from a union of the view tuples that satisfies the Boolean query Q based on the above scoring function.

### Process for Keyword Search Over Multiple Views

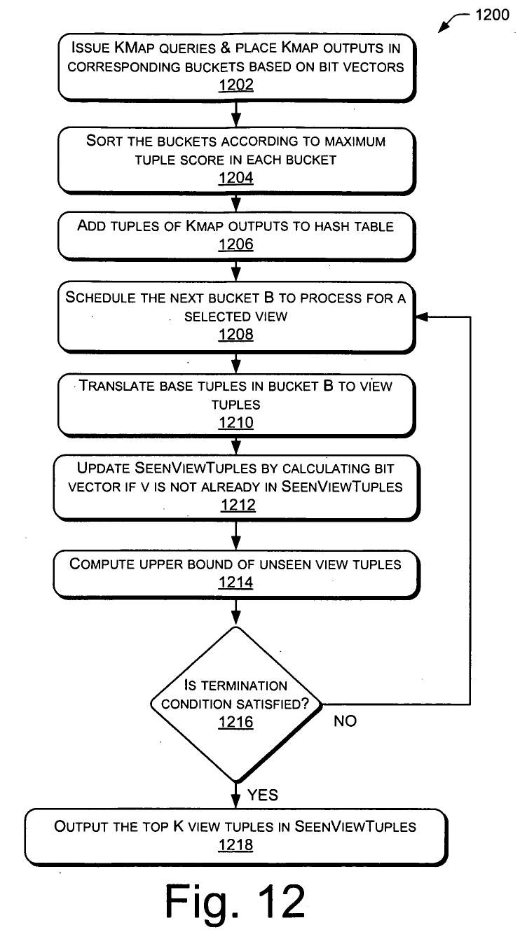

A process similar to that set forth above with respect to FIGS. 9 and 11 can be used to search each view and the individual view search results can then be combined to produce the final top K results. FIG. 12 illustrates a flowchart of an exemplary process 1200 for keyword searching over multiple views with early termination according to some implementations.

At block 1202, the process first issues KMap queries on the text columns of each of the multiple views, similar to block 902 above. However, even when the same base relation text column participates in multiple views, the process issues the KMap query only once for each base relation text column.

Blocks 1204 and 1206 correspond to blocks 904 and 906, respectively, described above, and thus, further description here is not necessary.

At block 1208, for a selected view, the process schedules a next bucket to process based on maximum score. Each view maintains its own frontier of exploration of the KMap results that are relevant to the view, i.e., the next unexplored bucket in each KMap and its own UnseenUB. During each iteration, the process first determines which view of the multiple views to search. For example, the process may pick the view with the highest UnseenUB.

At block 1210 the process translates the tuples in the scheduled bucket in the selected view.

At block 1212, the process maintains a global SeenViewTuples data structure for storing the seen view tuples, and the process updates the global SeenViewTuples for the selected view.

At block 1214, the process computes the global UnseenUB as the maximum of the UnseenUBs determined for each of the individual views.

At block 1216, the process then checks the termination condition using the global SeenViewTuples and global UnseenUB.

At block 1218, if the termination condition is satisfied, the process outputs the contents of the global SeenViewTuples and terminates; otherwise the process goes through the next iteration.

### Other Types of Views

Implementations described herein can be extended to views consisting of joins between primary key attributes and “group by” operators.

Key-key Join Views: Consider a database with two or more relations containing tuples that have a one-to-one relationship with each other and have the same primary key. For example, consider a customer name relation and a customer detail relation with the same primary key. In such cases, primary key-primary key join views are use to combine “related” information from the base relations, e.g., name and details of each customer. This is an important class of views since entities in ADO.Net Entity Framework correspond to this class of views. The ADO.Net Entity Framework is an object-relational mapping framework for the .NET Framework available from Microsoft Corporation of Redmond, Wash. The implementations described herein are directly applicable to such views except that the translation step is no longer necessary since the tuple ids from the different base relations can be directly intersected.

Group By Views: Consider a database with a relation Products[ProdId, ProdName, ProdDesc] containing name and descriptions of products and a relation Reviews[RevId, ProdId, ReviewTxt] containing reviews of those products. Consider the following view:

SELECT ProdName, ProdDesc, CONCAT(ReviewTxt)
FROM Products, Reviews
WHERE Products.ProdId = Reviews.ProdId
GROUP by ProdId

The above view “aggregates” all the information about a product (e.g., to generate a “product page” on an e-commerce portal such as Amazon.com). Many applications need to find relevant objects (e.g., products) through keyword searching. Implementations described above may be adapted to support keyword search on such views. First, the scoring framework needs to be adapted to. As before, each text column Vᵢ of V corresponds to text column Cᵢ of base relation Rᵢ. However, unlike in SPJ views where there is only one base tuple tᵢεRᵢ participating in a view tuple v for each text column Vᵢ, in these adapted implementations, multiple base tuples can participate for some text columns. For example, for the third text column of the above view, “ReviewTxt”, multiple tuples of Reviews can participate. Let Tᵢ⊂Rᵢ denote the set of base tuples participating in a view tuple v for text column Vᵢ. The score Score(vᵢ,Q) of column value vᵢ of view tuple v may then be defined as Aggₜε_{Ti}(CoOccur(t[Cᵢ]∩Q)×FTScore(Cᵢ, t[Cᵢ],OR(Q)) where Agg is a monotonic function (e.g., sum, max). The combination among various columns is performed as described above, so the overall score is Combine(Score(vᵢ,Q), . . . , Score(vₘ,Q)).

### Extensions to KMap API

Multi-column KMap: If FTS supports multi-column full text indexes on relations, it is more efficient to issue a single KMap query for all text columns in a relation instead of one KMap query per text column. In this case, the KMap API can be extended to return a bit vector and score per column. Implementations described above can be adapted for such a multi-column KMap API.

Positional Information: Another potential extension is to return, instead of just a bit per keyword, additional information, such as the term frequency and positional information for each keyword. Note that all this information is already present in the posting lists. This enables even richer scoring frameworks to exploit that information to compute the scores. For example, the scoring function can use the surfaced position information to compute a proximity score that goes beyond co-occurrence of keywords in the column to also consider their distances from each other.

### Experimental Evaluation

An extensive empirical study was conducted to evaluate the techniques described herein. The major findings of the study can be summarized as follows.

Most query keywords occur in multiple columns: Over 95% of the query keywords occur in multiple columns. This implies conventional explicit enumeration approaches will be inefficient as these approaches will have to issue a large number of FTS queries.

Efficient implementation of KMap: implementations of the KMap API with demonstrated to significantly outperform conventional techniques of issuing FTS queries for all valid keyword combinations.

Effectiveness of processes leveraging KMap and early termination: implementations described herein for leveraging KMap API and end implementing early termination or found to be an order of magnitude faster than conventional techniques that that do not use KMap API or that do not implement an early termination process. Some implementations described herein were found to be 2 to 3 times faster than some conventional early termination techniques for OR queries. For AND queries, implementations herein were found to be two orders of magnitude faster than some conventional early termination techniques.

Effectiveness of bucket ordering: Bucket ordering the KMap API outputs instead of sorting the tuples was found to significantly improve the execution time for early termination.

Benefit of Boolean expression pushdown: Pushing down the Boolean expressions into the bucket scheduler (i.e., below the translation join) was also found to boost performance for constrained queries.

### Exemplary Computing Implementation

Search module 210 described above can be employed in many different environments and situations for conducting keyword searching on database views. Generally, any of the functions described with reference to the figures can be implemented using software, hardware (e.g., fixed logic circuitry), manual processing, or a combination of these implementations. The term “logic, “module” or “functionality” as used herein generally represents software, hardware, or a combination of software and hardware that can be configured to implement prescribed functions. For instance, in the case of a software implementation, the term “logic,” “module,” or “functionality” can represents program code (and/or declarative-type instructions) that performs specified tasks when executed on a processing device or devices (e.g., CPUs or processors). The program code can be stored in one or more computer readable memory devices. Thus, the methods and modules described herein may be implemented by a computer program product. The computer program product may include computer-readable media having a computer-readable program code embodied therein. The computer-readable program code may be adapted to be executed by one or more processors to implement the methods and/or modules of the implementations described herein. The terms “computer-readable storage media”, “processor-accessible storage media”, or the like, refer to any kind of machine storage medium for retaining information, including the various kinds of storage devices discussed above.

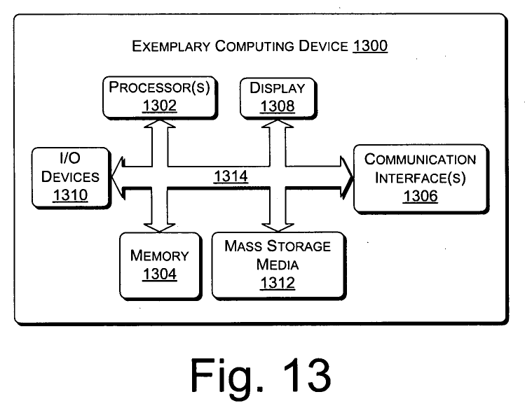

FIG. 13 illustrates an exemplary configuration of computing device and functionality implementation 1300 that can be used to implement the devices or modules described herein. The computing device 1300 includes one or more processors 1302, a memory 1302, communication interfaces 1306, a display 1308, other input/output (I/O) devices 1310, and one or more mass storage devices 1312 in communication via a system bus 1314. Memory 1304 and mass storage device 1312 are examples of the computer-readable storage media described above for storing instructions which perform the various functions described above when executed by the processing devices 1302. The computing device 1300 can also include one or more communication interfaces 1306 for exchanging data with other devices, such as via a network, direct connection, or the like, as discussed above. The display 1308 is a specific output device for displaying information, and is used to display results of the keyword searches described herein, such as the top K results. The other input/output devices 1310 are devices that receive various inputs from the user and provide various outputs to the user, and can include a keyboard, a mouse, audio input/output devices, a printer, and so forth. The c computing device 1300 described herein is only one example of a computing environment and is not intended to suggest any limitation as to the scope of use or functionality of the computer and network architectures that can implement keyword search on database views. Neither should the computing device 1300 be interpreted as having any dependency or requirement relating to any one or combination of components illustrated in the computing device implementation 1300. In some implementations, computing device 1300 can be, for example, server computing device 102, client computing device 106, or mobile computing device 108.

In addition, implementations herein are not necessarily limited to any particular programming language. It will be appreciated that a variety of programming languages may be used to implement the teachings described herein. Further, it should be noted that the system configurations illustrated in FIGS. 1, 2 and 13 are purely exemplary of systems in which the implementations may be provided, and the implementations are not limited to the particular hardware configurations illustrated.

### CONCLUSION

Implementations described herein efficiently support keyword searching on views of databases. Some implementations define and implement a keyword search KMap API that returns additional information about the presence of query keywords in the matching tuples. Further, some implementations leverage the KMap API to address the keyword-to-column assignment enumeration problem without issuing a large number of FTS queries, and are able to terminate early without sorting all of the results of FTS queries. Additionally, some implementations support a flexible scoring framework and arbitrary Boolean expressions (including AND and OR expressions) of keywords over one or more views. An extensive empirical evaluation using real datasets has demonstrated that the implementations described herein result in significant improvement over conventional approaches.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims. Additionally, those of ordinary skill in the art appreciate that any arrangement that is calculated to achieve the same purpose may be substituted for the specific implementations disclosed. This disclosure is intended to cover any and all adaptations or variations of the disclosed implementations, and it is to be understood that the terms used in the following claims should not be construed to limit this patent to the specific implementations disclosed in the specification. Rather, the scope of this patent is to be determined entirely by the following claims, along with the full range of equivalents to which such claims are entitled.

1. Computer readable storage media having computer readable program code embodied therein, the computer-readable program code adapted to be executed to implement a method comprising:
receiving a Boolean keyword search query for searching a view of a database, wherein the view is a virtual table that is not materialized that is generated by virtually joining one or more base relations stored in the database, wherein the view includes one or more text columns such that each text column is contained in a base relation of the view, wherein the keyword search query comprises a plurality of keywords connected by one or more Boolean operators;
executing a keyword search on each of the multiple text columns, wherein the executing the keyword search on each of the multiple text columns is based on the keyword query;
returning one or more highest scoring view tuples whose text column values together satisfy the Boolean expression on the keywords, wherein a relevancy score determined for each view tuple is based at least in part on a composition of keyword search scores of the text column values;
outputting results of the keyword search on each of the text columns, wherein the results include, for each base tuple, a tuple identifier, the relevancy score and a bit vector, wherein the bit vector is representative of which keywords from the query were located in the searched text column, wherein the bit vector for each result has a number of bit locations equal to a number and order of keywords contained in the keyword query;
storing the output results of the keyword search for each of the text columns in a plurality of buckets defined according to the bit vectors for each text column so that the output results are ordered according to the buckets;
identifying, for each bucket, a highest relevancy score from among the results stored in each bucket;
scheduling one or more buckets for processing by selecting buckets having a tuple with a highest relevancy score first in order to identify tuples most relevant to the keyword query as quickly as possible;
translating base tuples in the bucket being processed to determine corresponding view tuples in which the base tuples participate;
determining relevancy scores of those corresponding view tuples;
computing the bit vector of each view tuple from the bit vectors of the keyword search results for each text column;
filtering out view tuples that do not satisfy the Boolean expression on the keywords;
and
terminating processing of the buckets prior to processing all the buckets, and returning one or more view tuples in response to the keyword query when a total relevancy score of one or more view tuples in one or more processed buckets is determined to be greater than a possible maximum relevancy score of view tuples corresponding to buckets yet to be processed.

2. A method implemented by one or more processors executing instructions stored in computer-readable media, the method comprising:
receiving a keyword query for executing a keyword search on a view of a database, wherein the view includes multiple text columns of data;
executing the keyword search on each of the multiple text columns based on the keyword query, the keyword query comprising multiple keywords combined with one or more Boolean operators;
outputting results of the keyword search on each of the text columns, wherein the output results include a tuple identifier and a ranking for each base tuple in the results; and
identifying one or more highest-ranked view tuples that satisfies the Boolean expression on keywords in response to the keyword query.

3. The method according to claim 2,
wherein each text column is contained in a base relation of the view comprising a plurality of base tuples,
wherein the results output for each of the multiple text columns further include a bit vector for each base tuple in the results, and
wherein the bit vector indicates which keywords of the multiple keywords from the query are present in each corresponding base tuple.

4. The method according to claim 3, further comprising:
storing the results of the keyword search for each of the text columns in a plurality of buckets defined according to the bit vectors for each text column so that the results are ordered according to the buckets.

5. The method according to claim 4, further comprising:
identifying, for each bucket, a highest relevancy score from among the base tuples stored in each bucket;
scheduling one or more buckets for processing by selecting buckets having a tuple with a highest relevancy score first for identifying tuples most relevant to the keyword query as quickly as possible;
translating base tuples in the bucket being processed to determine the view tuples in which the base tuples participate;
terminating processing of the buckets prior to processing all the buckets, and returning one or more view tuples in response to the keyword query when a total relevancy score of one or more view tuples in one or more processed buckets is determined to be greater than an upper bound of view tuples corresponding to buckets yet to be processed.

6. The method according to claim 5,
wherein processing each bucket comprises finding the view tuples in which base tuples in the bucket participate, and determining the relevancy scores of those view tuples,
wherein the translating comprises issuing a query to a database management system that selects a base relation in the view corresponding to the bucket being processed, inserting tuple identifiers of the bucket into a temporary relation, and translating base tuples to view tuples based on the temporary relation and join conditions defining the view.

7. The method according to claim 6,
wherein the translating is optimized for primary key-foreign key joins when the selected base relation has a primary key column but does not have a foreign key column that references a primary key of another base relation,
wherein the optimization comprises avoiding joins with base relations that do not have a foreign key column and obtaining base tuple ids of such relations from the foreign key columns of other base relations that reference the primary key of such base relations,
wherein the join involves only the base relations having foreign key columns that reference the primary key of other base relations of the view.

8. The method according to claim 3,
wherein each text column is contained in a base relation of the view and comprises a plurality of base tuples,
wherein the results output for each text column further include a bit vector corresponding to one or more of the base tuples for each of the multiple text columns,
wherein the bit vector indicates which keywords of the multiple keywords from the query are present in each corresponding base tuple,
wherein the bit vectors of base tuples are combined to produce bit vectors of view tuples by representing in the bit vector that a particular keyword from the keyword query is present in at least one of the text columns of the view,
wherein the bit vector of each particular view tuple is produced by taking a bitwise OR of the bit vectors of the base tuples that participate in the particular view tuple.

9. The method according to claim 3, further comprising:
supporting arbitrary Boolean expressions in the keyword query by determining from the bit vectors which keywords from the keyword query are included in a view tuple.

10. The method according to claim 3, further comprising:
storing the output results of the keyword search on each of the text columns in a plurality of buckets defined according to possible bit vectors for each text column, wherein the bit vectors are representative of presence or absence of each of the keywords included in the keyword query in the text column;
identifying possible combinations of buckets by including in the possible combinations one bucket from each text column searched;
retaining the combinations of buckets that satisfy the Boolean expression in the keyword query; and
identifying results for the keyword query by processing only the buckets retained and not processing buckets not retained.

11. The method according to claim 3,
wherein there are multiple views, each view being comprised of one or more base relations from the database,
wherein the keyword query is applied to the multiple views by:
storing the output results of the keyword search for each of the text columns in a plurality of buckets defined according to possible bit vectors for each text column, wherein the bit vectors are representative of presence or absence of each of the keywords included in the keyword query in the text column;
identifying, for each bucket, a highest relevancy score from among the results stored in each bucket;
selecting a view and a bucket for processing the results stored in each bucket by selecting the view having a bucket with a highest relevancy score first;
processing the bucket in the selected view having the highest relevancy score first, wherein the processing comprises, for each base tuple in the bucket, joining corresponding base relations in the selected view to compute a total relevancy score for the view tuples in which the base tuple participates;
storing the view tuple identifier and total relevancy score for each processed result; and
terminating processing and returning one or more tuples corresponding to the stored view tuple identifiers in response to the keyword query when the total relevancy score of the one or more view tuple identifiers is determined to be greater than a maximum possible score of an unseen tuple yet to be processed in the multiple views.

12. The method according to claim 2, wherein the ranking of the results is based at least in part on a relevancy score, wherein the score includes a weighting factor applied to the results of one or more particular columns of the multiple columns based on a perceived degree of importance.

13. The method according to claim 2, where the keyword search on a view is expressed using a search API (application program interface) that takes as arguments the view to search, a set of text columns to search on, the Boolean keyword query, a number of view tuples desired and a monotone function to combine relevancy scores of individual column values and returns, at most, K highest scoring tuples of the view that satisfy the Boolean keyword query, wherein K is an integer greater than 0.

14. A system comprising:
a database;
one or more processors coupled to the database and coupled to computer readable storage media storing instructions for configuring the one or more processors,
wherein the one or more processors are configured to receive a keyword search query comprising multiple keywords and one or more Boolean operators for searching a view, wherein the view is a virtual table comprised of multiple text columns from one or more identified base relations in the database,
wherein the one or more processors are configured to perform a keyword search on the view by conducting a keyword search on each of the multiple text columns by determining whether each of the keywords included in the query is included in each text column, and
wherein the one or more processors are configured to output results of the keyword search conducted on each of the text columns, wherein the results include, for each base tuple, a tuple identifier and a bit vector, wherein the bit vector is representative of which keywords from the query are located in the searched text column.

15. The system according to claim 14,
wherein the bit vector for each result has a number of bit locations corresponding to a number and order of the keywords contained in the keyword query, wherein each bit location receives a first digit to represent presence of a corresponding keyword in the text column or a second digit to represent absence of the corresponding keyword in the text column.

16. The system according to claim 14,
wherein the results for each text column further include a relevancy score that represents a relevancy of the results to the keyword query, wherein the relevancy score includes a co-occurrence consideration that increases the relevancy of the results when multiple keywords from the search query are located in a single text column.

17. The system according to claim 16,
wherein the one or more processors are configured to determine tuple identifiers of the matching base tuples from each view text column searched, and combine the relevancy scores and bit vectors for the matching base tuples to obtain merged results for corresponding view tuples, and
wherein the one or more processors are further configured to filter the merged results to achieve a desired Boolean function, sort the filtered results according to the relevancy score for each result, and return one or more tuples having highest relevancy scores in response to the keyword query.

18. The system according to claim 14, further comprising:
a computing device in communication with a server device via a network, the computing device including a display,
wherein one or more of the one or more processors and the computer readable media are contained in the computing device,
wherein the server device is in communication with the database for providing the computing device access to the database, and
wherein contents of one or more tuples identified as the results are displayed on the display.

19. The system according to claim 14, further comprising:
a server computing device,
wherein one or more of the one or more processors and the computer readable storage media are contained in the server computing device, and
wherein the database is stored in a mass storage device accessible by the server computing device.

20. The system according to claim 14,
wherein the one or more processors are configured to store the output results of the keyword search for each of the text columns in a plurality of buckets defined according to the bit vectors for each text column searched,
wherein the one or more processors are configured to identify, for each bucket, a highest relevancy score from among the results stored in each bucket, and process the buckets having a higher relevancy score first, wherein the processing comprises, for each result in the bucket, obtaining corresponding tuple identifiers for merging the corresponding tuples to create a temporary relation and joining the temporary relation and corresponding base relations to compute a total relevancy score for a corresponding view tuple, and
wherein the one or more processors are configured to return one or more of the view tuples in response to the keyword query when the total relevancy score of the one or more view tuples is determined to be greater than a maximum possible score of an unseen tuple yet to be processed.
